(19) United States
(12) Patent Application Publication
(10) Pub. No.: US 2025/0272540 A1
(43) Pub. Date: Aug. 28, 2025

(54) SYSTEM AND METHOD FOR EMPIRICAL PROMPT TUNING

(71) Applicant: Actimize Ltd., Ra'anana (IL)

(72) Inventor: Ofir YAKOBI, Hod Hasharon (IL)

(73) Assignee: Actimize Ltd., Ra'anana (IL)

(21) Appl. No.: 18/585,203

(22) Filed: Feb. 23, 2024

(51) Int. Cl. G06N 3/0455

(52) U.S. Cl. CPC G06N 3/0455

(57) ABSTRACT

Systems and methods for selecting a prompt to input to a large language model (LLM), include: determining, by a predictive model and for a first set of data to be the subject of a prompt of a pre-defined set of prompts, a score for each prompt of the pre-defined set of prompts, wherein the score for each prompt is based on a predicted probability of receiving a defined feedback value on an output of the LLM generated based on that prompt and the first set of data; inputting to the LLM the prompt with the highest score and the first set of data; and outputting a result generated by the LLM based on the input prompt and the first set of data.

### FIELD OF THE INVENTION

The present invention relates generally to machine learning prompt engineering, in particular to incorporating user feedback into the prompt selection process.

### BACKGROUND OF THE INVENTION

Large language Models (LLMs) or other machine learning or generative artificial intelligence entities typically generate an output, such as a textual output, based on a received input prompt which instructs the LLM as to the type, content, or form of a desired output. However, LLMs often output “low quality” responses that either miss the intended information expected by the developer or output false information (e.g. “hallucinations” relating to made up information). At present, LLMs lack a direct mechanism for incorporating feedback during the generation process, making it impossible to control or fine-tune the output based on specific criteria.

Without an effective feedback integration mechanism, LLMs might produce a useless output, or output such as text that deviates from the desired context, tone, or intent, leading to issues such as bias amplification, factual inaccuracies, or inappropriate language.

Accordingly, there is a need in the art to develop methods and systems to efficiently integrate feedback in LLMs to ensure more reliable and controllable output or text generation, making them more adaptable to various applications and user needs.

### SUMMARY

Embodiments of the invention include a method for selecting a prompt to input to a large language model (LLM), including determining, by a predictive model and for a first set of data to be the subject of a prompt of a pre-defined set of prompts, a score for each prompt of the pre-defined set of prompts, wherein the score for each prompt is based on a predicted probability of receiving a defined feedback value on an output of the LLM generated based on that prompt and the first set of data; inputting to the LLM the prompt with the highest score and the first set of data; and outputting a result generated by the LLM based on the input prompt and the first set of data.

According to some embodiments, the predictive model is pre-trained based on feedback values for a training set of outputs of the LLM generated based on each prompt of the pre-defined set of prompts and one or more training sets of data.

According to some embodiments, the first set of data is a set of tabular data.

According to some embodiments, the method includes receiving a feedback value on the output result generated by the LLM.

According to some embodiments, the feedback value includes one of: binary feedback; a rating on a scale; or a rating on a scale converted from textual feedback.

According to some embodiments, the feedback value on the output result generated by the LLM is used to further train the predictive model.

According to some embodiments, feedback value on the output result generated by the LLM is used to create at least one new prompt to be added to the pre-defined set of prompts.

According to one or more embodiments of the invention there is also provided a system for selecting a prompt to input to a large language model (LLM), the system including: at least one computer processor; and a computer readable storage medium comprising instructions which, when executed by the at least one computer processor, cause the at least one computer processor to: execute a predictive model to determine, for a first set of data to be the subject of a prompt of a pre-defined set of prompts, a score for each prompt of the pre-defined set of prompts, wherein the score for each prompt is based on a predicted probability of receiving a defined feedback value on an output of the LLM generated based on that prompt and the first set of data; input, to the LLM, the prompt with the highest score and the first set of data; and output a result generated by the LLM based on the input prompt and the first set of data.

According to some embodiments, the predictive model is pre-trained based on feedback values for a training set of outputs of the LLM generated based on each prompt of the pre-defined set of prompts and one or more training sets of data.

According to some embodiments, the first set of data is a set of tabular data.

According to some embodiments, the at least one computer processor is configured to receive a feedback value on the output result generated by the LLM.

According to some embodiments, the feedback value includes one of: binary feedback; a rating on a scale; or a rating on a scale converted from textual feedback.

According to some embodiments, the at least one computer processor is configured to use the feedback value on the output result generated by the LLM to further train the predictive model.

According to some embodiments, the at least one computer processor is configured to use the feedback value on the output result generated by the LLM to create at least one new prompt to be added to the pre-defined set of prompts.

According to one or more embodiments there is also provided a method for determining an input to a first generative artificial intelligence, the method comprising: determining a score for one or more candidate inputs, the score based on a likelihood of receiving positive feedback on an output of the first generative artificial intelligence generated from the candidate input; and identifying the candidate input with the best score.

According to some embodiments, a candidate input includes a table of data and a prompt to summarize the table of data.

According to some embodiments, positive feedback comprises at least one of: an assigned positive value of binary feedback; a value relating to user input from an assigned positive graphic element of a user interface; a value within a predefined range of rating values on a scale; or textual feedback converted to a rating value on a scale by a second generative artificial intelligence configured to analyze textual feedback for positive keywords, wherein a predefined range of rating values on the scale are assigned as relating to positive feedback.

According to some embodiments, the method further includes: submitting the candidate input with the best score to the first generative artificial intelligence; and receiving an output of the first generative artificial intelligence generated from the candidate input with the best score.

According to some embodiments, the method further includes receiving feedback on the output of the first generative artificial intelligence generated from the candidate input with the best score.

According to some embodiments, the feedback is used to improve the step of determining a score for future candidate inputs.

### BRIEF DESCRIPTION OF THE DRAWINGS

Non-limiting examples of embodiments of the disclosure are described below with reference to figures attached hereto. The dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIGS. 1A and 1B show example prompts, according to some embodiments of the invention;

FIG. 2 shows three different example LLM outputs presented as part of a user interface, according to some embodiments of the invention;

FIG. 3 shows a flowchart of a method for selecting a prompt to input to a large language model, according to some embodiments of the invention;

FIG. 4 shows an example use case of some embodiments of the invention;

FIG. 5A shows schematically a typical process for generating an LLM response;

FIG. 5B shows schematically a process for generating an LLM response according to some embodiments of the invention;

FIG. 6A shows schematically an example process of prompt selection, according to some embodiments of the invention;

FIG. 6B shows a schematic focused view of a prompt selector shown in FIG. 6A, according to some embodiments of the invention;

FIG. 7 shows schematically an example process, according to some embodiments of the invention;

FIG. 8 shows an example data structure, according to some embodiments of the invention.

FIG. 9 shows a flowchart of a method for determining an input to a generative artificial intelligence, according to some embodiments of the invention;

FIG. 10 shows data for the books Jane Eyre, pride and Prejudice, The Lord of the Rings: The Fellowship of the Ring, 1984, To Kill a Mockingbird, The Hobbit, and Harry Potter and the Sorcerer's Stone, used by a simulation according to some embodiments of the invention;

FIG. 11A is a graph showing overall positive feedback average as a function of prompt index, according to some embodiments of the invention;

FIG. 11B is a graph showing how the year of publication influences the feedback as a function of prompt index, according to some embodiments of the invention; and

FIG. 12 shows a block diagram of an exemplary computing device which may be used with some embodiments of the present invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

Embodiments of the invention relate generally to selecting a prompt to input to a generative machine learning or artificial intelligence (AI) such as a large language model (LLM). The LLM may be accessed locally (e.g. a local LLM run on NICE Actimize servers) or as part of a software as a service (SaaS model), such as OpenAI's ChatGPT.

In the context of natural language processing, a prompt may refer to a specific input provided to an AI model such as an LLM, serving as a starting point or context for the model to generate a particular output. A prompt can be a question, an incomplete sentence, or a description, or another text string, guiding the AI to produce relevant and coherent responses. Crafting an effective prompt may be important as the prompt influences the quality and relevance of the generated output. According to some embodiments of the invention, a prompt may be a textual instruction to an LLM to summarize data, for example “Summarize the data below.” As used herein, a prompt template may refer to a prompt without accompanying data, for example a prompt template may include a fixed textual portion and a variable portion, where the variable portion may include, for example, a set of data to be inserted into or otherwise integrated with the prompt template.

According to some embodiments of the invention, instead of just one prompt, a pre-defined set of prompts may be used, and one prompt will be chosen each time according to the data that is being sent with it. Prompts within the set may be similar to one another, for example variations on the same instruction. In some embodiments, the set of prompts can be modified by including new prompts and/or eliminating underperforming ones.

As discussed, without effective feedback integration mechanisms, LLMs might produce useless text which deviates from the desired context, tone, or intent behind a prompt. This may result in issues such as bias amplification or factual inaccuracies. These issues may be even more pronounced when attempting to integrate tabular data, e.g. data in rows and columns, such as a table (which can be of varying length and quality), into the prompt. Tabular data may include comma separated values. Accordingly, embodiments of the present invention which integrate feedback from previous generated outputs, particularly for outputs generated based on input data such as tabular data, may be used to help improve the selection of the most suitable prompt for a particular type of data in order to elicit a desired result, such as receiving positive feedback.

As described further herein, positive feedback may relate to user input that a generated output (e.g. generated by a generative artificial intelligence such as an LLM) did an excellent, good, or otherwise suitable job of analyzing, describing, or otherwise summarizing a set of data input by the user. Negative feedback may relate to user input that the generated output did a terrible, bad, poor or otherwise unsuitable job of analyzing, describing, or otherwise summarizing the set of data. Feedback may be received in the form of a feedback value. Different types of feedback value are described further herein, and may include, for example: binary feedback; a rating on a scale; or a rating on a scale converted from textual feedback.

In some embodiments, implicit feedback may be gathered, for example: using browser cookies; monitoring whether a user copy-and-pasted a generated output for subsequent use; and/or monitoring a dwell time. The dwell time may be a duration between a user running a first request for an LLM to summarize input data, and a second request for the LLM to summarize the same data: a short dwell time may indicate that the user was not satisfied by the generated output, whereas a longer dwell time may indicate that the user was satisfied by the generated output.

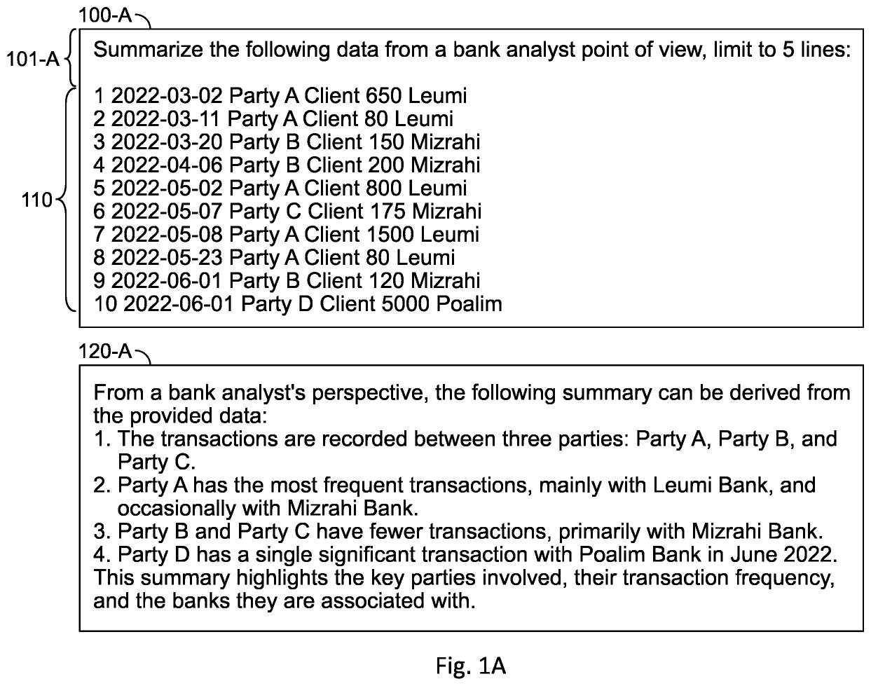

FIGS. 1A and 1B show example prompts, according to some embodiments of the invention. Prompt 100-A includes a textual prompt portion 101-A, here “Summarize the following data from a bank analyst point of view, limit to 5 lines.” Textual prompt portion 101-A includes a command to summarize the data, a desired point of view (e.g. a perspective or role which the LLM should take on), and an instruction to limit the output. Prompt 100-A includes a data portion 110 which is a set of tabular data included as part of the prompt. In the example shown, the tabular data 110 relates to transaction data, but any other type of data can be used. The set of data 110 may be considered as the subject of the prompt, because the purpose of the prompt is to instruct the LLM to summarize the included data.

Example output of an LLM generated based on prompt 100-A is shown as 120-A (different LLMs or machine learning models may produce different output). The LLM output 120-A gives a summary of the content of the set of data 110, from the point of view of a bank analyst, and in no more than 5 lines as per prompt 100-A.

FIG. 1B shows a different example prompt 100-B, with textual prompt portion 101-B “Find patterns and anomalies in the following data, mention any suspicious activity in the last transaction, limit your answer to 3 lines.” Textual prompt portion 101-B includes a command to identify patterns and anomalies, a command to discuss any suspicious activity, and an instruction to limit the output.

Prompt 100-B includes a data portion 110 which is a set of tabular data included as part of the prompt. In the example shown, the tabular data 110 is the same as provided with prompt 100-A. Again, the set of data 110 may be considered as the subject of the prompt, because the purpose of the prompt is to instruct the LLM to analyze the included data.

Example output of the LLM generated based on prompt 100-B is shown as 120-B. Despite using the same set of data 110, the same LLM has generated a different output to that of 100-A because of the different textual portion of the prompt.

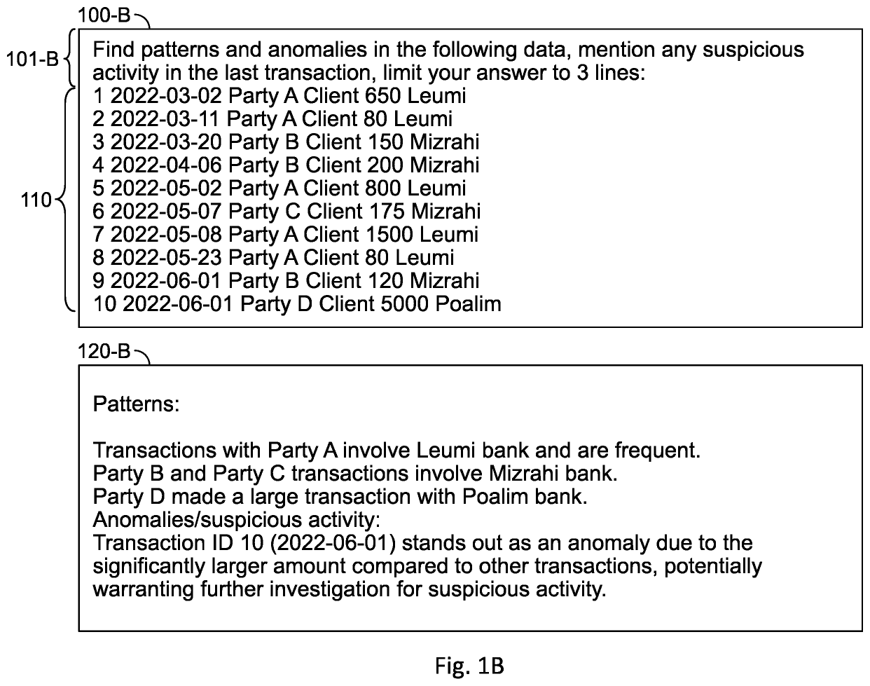

FIG. 2 shows three different example LLM outputs presented as part of a user interface, according to some embodiments of the invention. Outputs 210, 220, and 230 relate to the same set of data (in this example bank's client transaction summary presented as a data table) but summarized using different prompts. The content, detail and quality of the outputs vary between outputs 210, 220, and 230: for example a shorter summary in output 220 (compared with output 210), and a lack of details in output 230. Each output may be useful in different contexts or for different levels of generality.

FIG. 2 also shows an example of a feedback mechanism. Graphic symbols of a thumbs down (200) and a thumbs up (201) may allow a user (such as a human user) to provide feedback. This type of feedback may be referred to as binary feedback, for example either negative feedback received by a user pressing, clicking, interacting with, or otherwise selecting thumbs down 200 (e.g. using a user terminal) which may be converted by a computing device to a value of “0” (zero) representing negative feedback, or positive feedback received by a user pressing, clicking, interacting with, or otherwise selecting thumbs up 201 which may be converted by a computing device to a value of “1” (one) representing positive feedback.

Other graphic symbols may be used for providing feedback, such as a smiley face (e.g. an emoji) to indicate positive feedback, a sad face to indicate negative feedback, an upwards pointing arrow to indicate positive feedback (e.g. an upvote), a downwards pointing arrow to indicate negative feedback (e.g. a downvote), or the like.

Other feedback mechanisms may be used by some embodiments of the invention. For example, a user may provide feedback in the form of a rating or value on a scale, for example a rating from 1-10. A rating of 1 may indicate that the generated result was very poor quality or otherwise unfit for purpose, and a rating of 10 may indicate that the generated result was of very good quality and highly relevant. Intermediate values between 1 and 10 may be used to indicate varying grades of quality between the extremes. A predefined range of values on the scale may be assigned as relating to positive feedback, e.g. a value from 6 to 10 on a scale of 1 to 10, and values outside of that range may be interpreted as relating to negative feedback.

Equivalent rating scales or definitions, such as inverted meanings of the ends of the scale (e.g. 10 being poor, 1 being good), smaller or larger scales (e.g. 0-5, 1-100), and/or defining a range of values on the scale as relating to negative feedback, e.g. a value from 1 to 5 on a scale of 1 to 10 with values outside this range being considered positive, may be used.

As another example of a feedback mechanism, some embodiments of the invention may use feedback based on textual or written input from a user. For example, a user may provide textual input (e.g. using a user interface) in relation to a generated LLM output, such as “super helpful” or “not relevant”. Textual feedback may be received by methods and systems of the present invention, and may be processed by a second generative AI, such as a second LLM configured to analyze the textual feedback for keywords such as positive keywords (e.g. “good”, “helpful”, “great”) and/or negative keywords (e.g. “bad”, “useless”, “poor”). The second LLM may be trained to identify the keywords and generate, derive, or otherwise produce a rating value on a feedback scale representing a numeric conversion of the textual feedback to a quantifiable level of feedback. A predefined range of values on the scale may be assigned as relating to positive feedback, e.g. a value from 6 to 10 on a scale of 1 to 10.

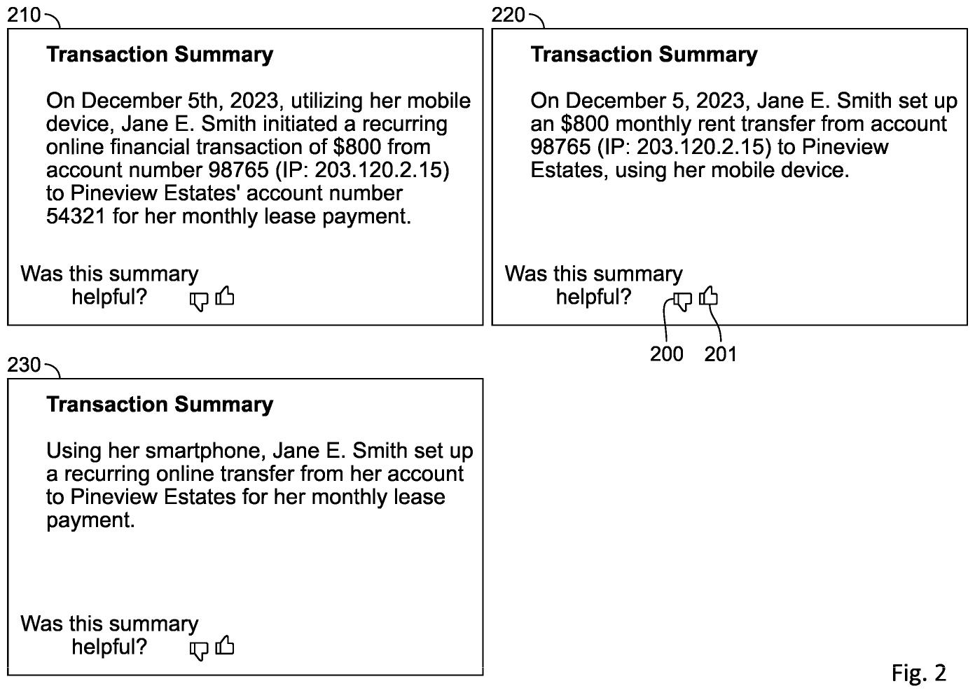

FIG. 3 shows a flowchart of a method 300 for selecting a prompt to input to a generative AI such as a large language model, according to some embodiments of the invention.

Method 300 may include defining a set of prompts (Step 301). Prompts within the set of prompts may be manually created (e.g. devised) by experts such as prompt engineers, data scientists, and/or subject matter experts, and stored digitally. The prompts may be created to be different variations of “Summarize the data below”. The prompts may be created to take into account different roles or points of view that the LLM should assume.

Method 300 may include determining, by a predictive model and for a first set of data to be the subject of a prompt of the pre-defined set of prompts (e.g. defined in Step 301), a score or rating for each prompt of the pre-defined set of prompts (Step 310).

The predictive model may be a statistical or probability-based computer model. In some embodiments, the predictive model is pre-trained based on feedback values for a training set of outputs of the LLM generated based on each prompt of the pre-defined set of prompts and one or more training sets of data. For example, training sets of data may include a set of data that was input to the LLM, the prompt that was input to the LLM, the output of the LLM, and/or a received feedback value received for the output of the LLM. These training sets of data may characterize historic inputs, outputs and feedback, and may be used to train or further improve the training of the predictive model.

The predictive model may use XGBOOST (Extreme Gradient Boosting). XGBoost is an optimized distributed gradient boosting library designed to efficiently handle large and complex datasets. It is an open-source machine learning library that implements the gradient boosting framework. XGBoost is known for its speed and performance, often outperforming other algorithms in various machine learning competitions. It can be used for both regression and classification tasks and is widely popular for its ability to handle diverse data types and feature interactions effectively. In some embodiments of the invention, a structure whereby a separate model for each prompt (rather than e.g. using one model for all predefined prompts) is used. This may allow to add new prompts at a later stage without the needing to retrain one overall model on the complete dataset of training data.

Returning to step 310, the first set of data may be a set of data to accompany a prompt, and thus may be the subject of that prompt. For example, the prompt may be a prompt to summarize the set of data, such as shown in FIGS. 1A and 1B. In some embodiments, the first set of data is a set of tabular data.

The pre-defined set of prompts may include one or more example or template prompts ranging from broad applicability to specific adaptation for certain circumstances. In contrast to existing prior art generative AIs, such as ChatGPT, embodiments of the invention may remove the human element of writing a prompt, and instead select a prompt from a pre-defined set of prompts. The selected prompt may be selected according to embodiments of the invention so as to maximize the likelihood of receiving positive feedback for an end generated result from an LLM, based on the specific type of data to accompany the prompt. Accordingly, some embodiments of the invention remove the need for static (e.g. unchanging) prompts and instead employ a dynamic prompt selection tailored to the specific input data based on predicted performance learnt from historic and/or ongoing feedback values.

The score for each prompt may be based on a predicted probability of receiving a defined feedback value on an output of the LLM generated based on that prompt and the first set of data. A defined feedback value may be a target numeric value or range of values characterizing the desired feedback outcome, such as a target value of 9 on a scale of 1 to 10, or a value within a target range of 6-10 on a scale of 1 to 10. In binary feedback mechanisms, the defined feedback value may be 1, e.g. the score is a predicted probability of receiving a feedback value of 1 (positive feedback) on an output of the LLM generated based on that prompt and the first set of data.

For example, the score may relate to a likelihood of that prompt receiving positive feedback (e.g. a defined feedback value of 1 in a binary feedback system, or a defined feedback value within the range 6-10 in a ratings scale feedback system, as discussed herein). An embodiment may iterate over each prompt of the set of prompts to determine a score for each prompt of the set of prompts.

A score may be based at least in part on, e.g. may be influenced by, the first set of data. For example, based on the training of the predictive model for historic sets of training data it may be determined that the same prompt results in different quality LLM outputs (the quality determined by feedback) for different types of sets of data. For example, for a given prompt, data relating to credit card transactions may be summarized well by the prompt and receive positive feedback, but the same prompt may not deal so well with a different format of data such as a bank statement history which includes many more variables such as deposits, transfers, accumulated interest, etc. Accordingly, the score may relate to the expected (e.g. predicted) performance of a given prompt for the particular data to be the subject of the prompt, based on historic feedback for that prompt with different types of data.

Method 300 may include inputting to the LLM the prompt with the highest score and the first set of data (Step 320). For example the prompt with the highest predicted probability of receiving the defined feedback value may be submitted or input to the LLM together with, integrated with, or otherwise accompanied by, the first set of data.

Method 300 may include outputting a result generated by the LLM based on the input prompt and the first set of data (Step 330). For example, the generated output of the LLM may be a summary of the first set of data in cases where the input prompt is related to an instruction to summarize the first set of data. The output result generated by the LLM may be presented to a user on a display or part of a user interface.

In some embodiments, method 300 further includes receiving a feedback value on the output result generated by the LLM. For example, a user may provide feedback on the output of the LLM. The feedback value may include one of: binary feedback; a rating on a scale; and/or a rating on a scale converted from textual feedback, as discussed herein.

In some embodiments, the feedback value on the output result generated by the LLM is used to further train the predictive model. For example, the training of the predictive model may be continuously improved and built upon from “live” feedback received in respect of LLM outputs generated based on new sets of data. In this way, embodiments of the invention may improve the accuracy of selecting the best prompt for a given kind of data.

In some embodiments, the feedback value on the output result generated by the LLM is used to create at least one new prompt to be added to the pre-defined set of prompts. For example, negative feedback, in particular very negative feedback (such as consistently received instances of negative feedback for this prompt for many different types of sets of data) may indicate that the selected prompt is not suitable and should be replaced in the set of prompts by a new prompt.

As another example, a prompt which consistently receives mid-range feedback for many different types of sets of data (e.g. neither positive nor negative, such as a value of 5 on a scale from 1-10) may indicate that the prompt should be rewritten or adapted. A rewritten prompt may replace the original prompt, or may be added to the pre-defined set of prompts alongside the original prompt.

Feedback data (e.g. feedback values) for new prompts may be collected. Feedback data for new prompts may be simulated, for example by asking a second LLM to provide feedback on a response generated based on the new prompt by a first LLM. Simulated feedback data may be used by the predictive model until sufficient “live” feedback data has been collected for the new prompt.

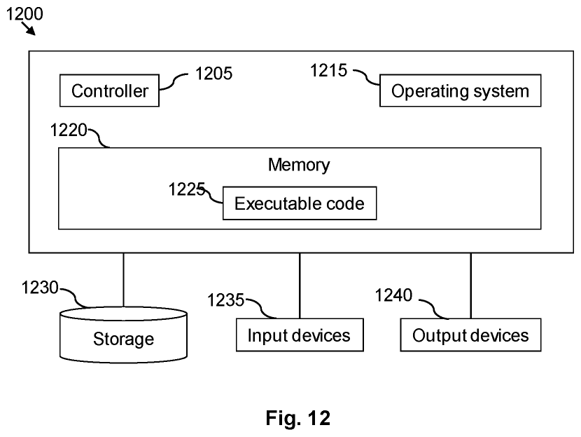

Method 300 may be performed by a system for selecting a prompt to input to a large language model. For example, a system according to some embodiments of the invention may include at least one computer processor; and a computer readable storage medium comprising instructions which, when executed by the at least one computer processor, cause the at least one computer processor to carry out one or more methods according to embodiments of the invention, such as method 300. The at least one computer processor and/or computer readable storage medium may be, or may be part of, a computing device such as computing device 1200 shown in FIG. 12 and described further herein.

For example, a system for selecting a prompt to input to a large language model may include a computing device configured to: execute a predictive model to determine, for a first set of data to be the subject of a prompt of a pre-defined set of prompts, a score for each prompt of the pre-defined set of prompts; input, to the LLM, the prompt with the highest score and the first set of data; and output a result generated by the LLM based on the input prompt and the first set of data.

As described herein, the score for each prompt may be based on a predicted probability of receiving a defined feedback value on an output of the LLM generated based on that prompt and the first set of data.

In some embodiments, the at least one computer processor is configured to receive a feedback value on the output result generated by the LLM, for example a feedback value which includes one of: binary feedback; a rating on a scale; or a rating on a scale converted from textual feedback, as described herein.

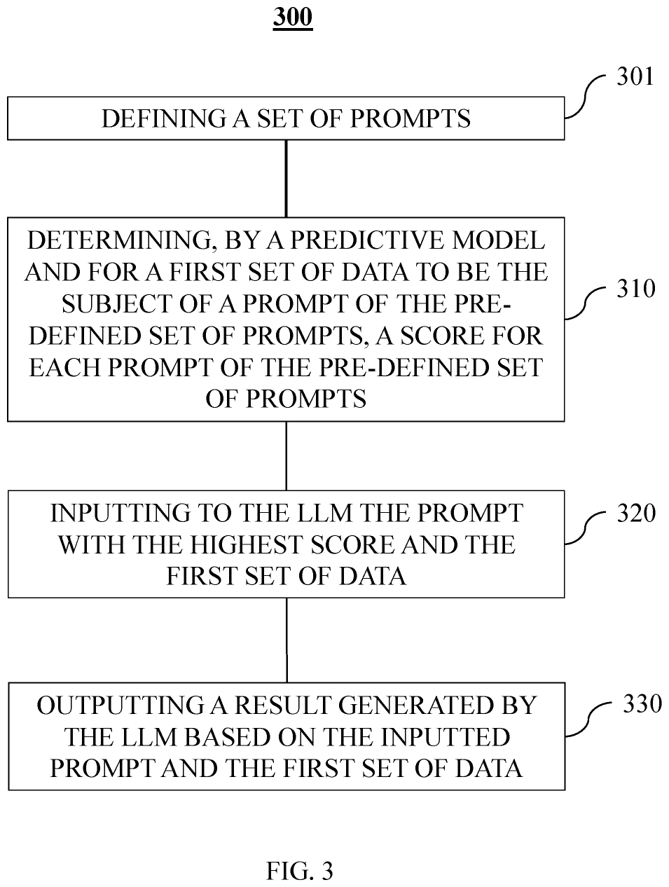

FIG. 4 shows an example use case of some embodiments of the invention. A client, such as a financial institution 410, may send transactions data 415 from a user terminal 411 over a network such as a wide area network (WAN) 420. Other types of clients, other types of data and other types of networks may be used. Client 410 may be connected to network 420 via one or more network elements such as a router 425.

Data 415 may be sent to a service provider 430, for example a service provider offering software as a service (SaaS). In the example shown, the service provider 430 is NICE Actimize. Service provider 430 may receive the data 415 (for example over network 420) and may analyze data 430 according to embodiments of the invention. For example, one or more servers 432 and/or databases 436 configured for carrying out embodiments of the invention may select a prompt for input to an LLM (which may be located externally, e.g. via a cloud service 440) based on data 415. An LLM output 435, for example an LLM output generated based on a selected prompt selected according to one or more embodiments of the invention described herein, may be sent back to client 410, for example over network 420.

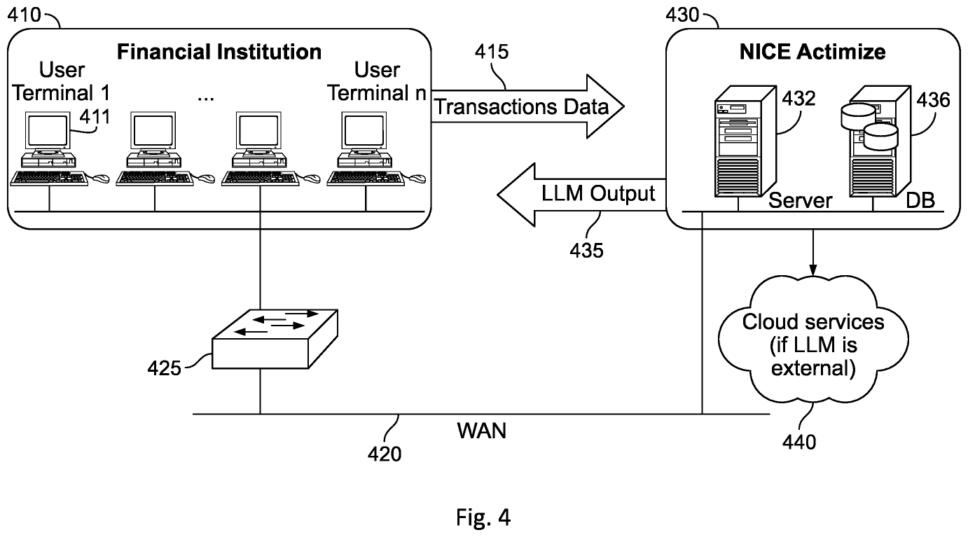

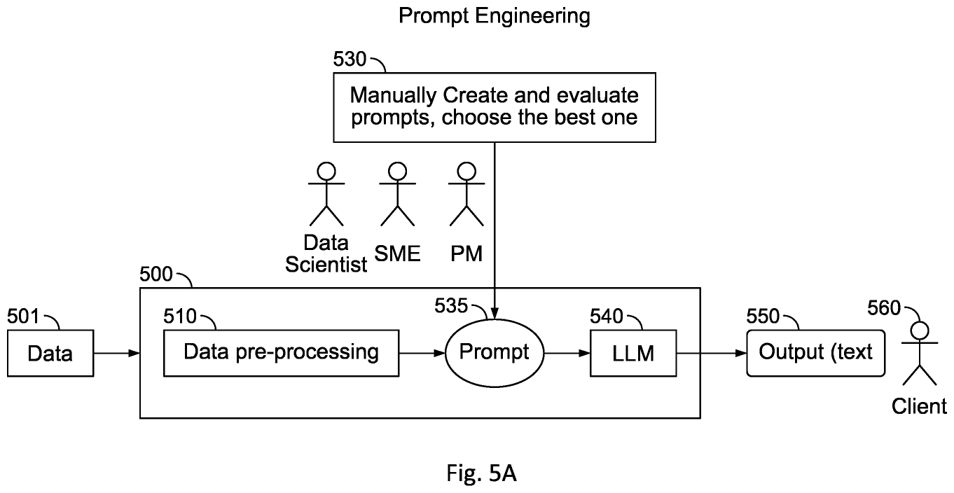

FIG. 5A shows schematically a typical process for generating an LLM response, and FIG. 5B shows schematically a process for generating an LLM response according to some embodiments of the invention. With reference to FIG. 5A, typically experts manually create prompts in a process known as prompt engineering (530), for example by experimenting with different prompts and examining the output of an LLM based on a specific dataset. These experts may decide if the output is good or bad. Example types of experts which may be involved in the manual creation of prompts include data scientists, subject matter experts (SMEs) and project managers. The prompts created as part of prompt engineering 530 may be input to a system, such as system 500 shown schematically, and may be stored in one or more databases. System 500 may be configured to integrate data, e.g. data 501, into the prompt. Data 501 may undergo data pre-processing 510. System 500 may be configured to submit the prompt 535 to an LLM 540, which may output a resulting text 550 to a client 560.

With reference now to FIG. 5B, embodiments of the invention may involve modifications to the typical process shown in FIG. 5A.

For example, a system, such as system 505 shown schematically, may receive data 501. Data 501 may be a set of data, such as tabular data. Data 501 may be data which is to be integrated into a prompt for input to an LLM 540.

Data 501 may undergo data pre-processing, as shown schematically by block 510. A classifier 520 for choosing prompts may make one or more predictions 524 about the expected performance (e.g. an expected feedback value to be received), and output a score or rating. Classifier 520 may be a predictive model, e.g. an AI or neural network model, configured to make predictions 524 based on model training 522 and one or more prompts stored in a database 526. The model training may include training techniques disclosed herein. For example, classifier 520 may be pre-trained (e.g. use model training 522) based on feedback values for a training set of outputs of the LLM generated based on each of the one or more prompts stored in database 526.

Predictions 524 may be based on a score for each prompt 535 that is based on a predicted probability of receiving a defined feedback value on an output of LLM 540 generated based on that prompt and data 501. The predicted probability may be calculated based on the training of the predictive model on historic training sets of data: for example based on the number of times that a given prompt received a particular feedback value for a certain type or style of input data.

Based on prediction 524, system 505 may select the prompt 535 that has the best prediction, e.g. the highest score, for example the prompt 535 that maximizes the probability of receiving a defined feedback value, such as the prompt with the highest probability of receiving positive feedback for binary feedback mechanisms.

The selected prompt 535 may be input to LLM 540. The selected prompt 535 may be input to LLM together with data 501. LLM 540 may use generative artificial intelligence processes known in the art to generate an output 550 based on the input prompt. Output 550 may be a text output.

System 505 may send output 550 to client 560. For example system 505 may send output 550 to client 560 over a network (such as WAN 420 shown in FIG. 4). Client 560 may view output 550 on a display, such as a display of a user terminal (e.g. user terminal 411 shown in FIG. 4). Output 550 may look similar to output 120-A shown in FIG. 1A, output 120-B shown in FIG. 1B and/or outputs 210, 220, and 230 shown in FIG. 2. Client 560 may provide feedback 570 on output 550. For example, client 560 may use a user terminal (e.g. user terminal 411 shown in FIG. 4) to interact with one or more graphic symbols for providing feedback (such as thumbs down 200 or thumbs up 201 shown in FIG. 2). Client 560 may be asked, for example by an in-system message on a user terminal, to provide a feedback rating on a scale, such as a rating from 1 to 10. Client 560 may be asked, for example by an in-system message on a user terminal, to provide written or textual feedback, for example by being asked to write a review of output 550.

Feedback 570 received from client 560, may be stored in database 526. Feedback 570 may be processed. For example where feedback 570 includes written or textual feedback from client 560, system 505 may convert the written or textual feedback into a rating on a scale, for example using a second LLM trained to analyze written or textual feedback for keywords and assign a rating on a scale based on the overall positive or negative content of the written or textual feedback.

Embodiments of the invention may include offline research 532. For example, researchers, which may include data scientists, subject matter experts and PMs may craft prompt templates, such as new prompt templates, based on research. This may improve initial prompt engineering 530, which may include the manual creation of a number (e.g. an integer k) of prompt templates.

For example, offline research could lead to new insights regarding how prompts should be crafted in the specific context, and what the relationship between the data and prompt feedback might be. For example, if one of the data items included in the set of data is “transaction type” (e.g., money transfer, check deposit), and the data scientist identifies that the summarization of check deposit transaction benefit from prompts that elicit short output then the data scientist may ensure that some prompts in the prompt stack explicitly include such instructions. Automated systems for identifying trends in the data may be used alongside or instead of human experts, for example one or more artificial intelligence models.

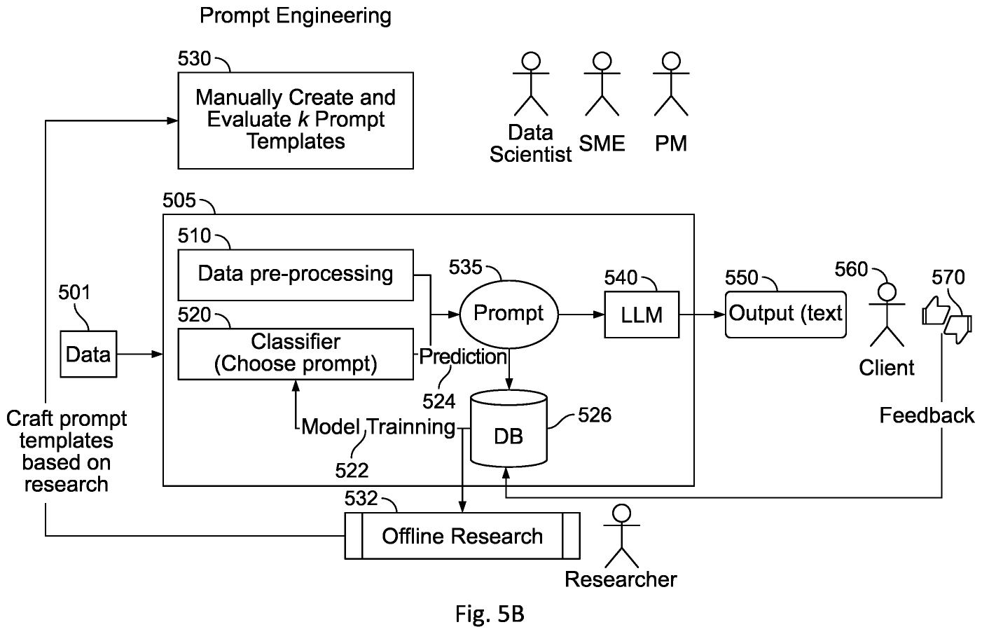

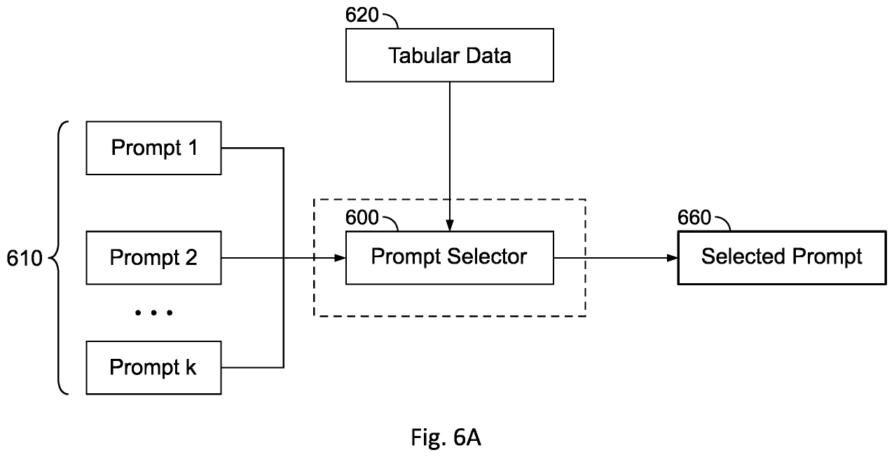

FIG. 6A shows schematically an example process of prompt selection, according to some embodiments of the invention. A prompt selector 600 may select a prompt to input to a large language model according to one or more methods disclosed herein. A predefined set 610 of prompts may include k prompts, k being an integer.

Prompt selector 600 may receive data, such as tabular data 620. Prompt selector 600 may select a prompt 660 from among prompts 1, 2, . . . , k of pre-defined set of prompts 610 for input to an LLM. FIG. 6B shows a schematic focused view of prompt selector 600 shown in FIG. 6A, according to some embodiments of the invention.

Prompt selector 600 may perform pre-processing 622 on tabular data 620. Pre-processing 622 may include missing value handling 640, and/or outlier removal 642.

For example, missing value handling 640 may include imputing one or more missing entries in tabular data 620, such as by assigning a data value by inference from the other data value to which it contributes. For example, missing value imputation may include: looping through each column in tabular data 620; checking if the column contains any missing values; if missing values are present, calculating the mean of the non-missing values in that column (e.g. for numeric values calculating the arithmetic mean, and for categoric values calculating the modal (most frequent) value); replacing the missing values in that column with the calculated mean; and repeating this process for each column in the dataset.

Outlier removal 642 may include the removal of anomalous data values, such as data values that have a statistically large deviation from the pattern or distribution of the other data values. For example, outlier removal 642 may include: Identifying a target numerical column (e.g., “feature 1”) in tabular data 620; calculating the first quartile (Q1) and third quartile (Q3) of “feature1”; computing the interquartile range (IQR) as the difference between Q3 and Q1; defining a lower bound as Q1−1.5*IQR and an upper bound as Q3+1.5*IQR; and identifying and removing data values in “feature 1” that fall outside the defined lower and upper bounds.

Prompt selector 600 may perform feature engineering 624 on tabular data 620. Feature engineering may be performed as part of pre-processing 622, in which case the feature engineering may be represented in FIG. 6B by reference numeral 646. Feature engineering 624 and/or 646 may include, for example, the creation of new features from existing features, such as the multiplication of two columns of the tabular data to produce a new column. Feature engineering 624 and/or 646 may include, for example, converting date columns in tabular data 620, e.g. ensuring that an “account date creation” and “transaction date” column are in a date format and if not converting them to a date format using appropriate functions. Feature engineering 624 and/or 646 may include, for example, calculating a date difference and adding the difference as a new column, e.g. for each row in tabular data 620, calculating a time difference (e.g. in days) between an “account date creation” and a “transaction date”, which may be done using a date subtraction operation.

Prompt selector 600 may execute a number of predictive models 626, for example a number of predictive equal to the number of prompts, each predictive model corresponding to one of the k prompts. Predictive models 626 may be, for example, based on XGBoost. As described herein, in structures according to embodiments of the invention, a separate predictive model for each prompt is used which facilitates adding new prompts at a later stage without the need to retrain the individual models on the complete dataset to account for the addition of new prompts.

Predictive models 626 may be pre-trained predictive models 648. The training may be based on historic data, for example historic pre-processed data. Training data, such as historic data, may be labelled. The labels may correspond to user feedback. The labels may be pre-processed, e.g. dichotomize a continuous user ranking.

According to some embodiments of the invention, the model training includes one or more of the following steps: splitting the data, e.g. dividing the dataset into training and testing sets; defining parameters, e.g. specifying XGBoost parameters such as objective function, evaluation metric, max depth, learning rate, subsample, colsample_bytree, and the number of estimators; creating a DMatrix, e.g. converting the training and testing sets into an XGBoost DMatrix for efficient handling; training the model, e.g. using the xgb.train function to train the XGBoost model with the defined parameters; making predictions, e.g. generating predictions 650 on the test set using the trained model; converting to binary predictions, e.g. threshold predicted probabilities to obtain binary predictions (e.g. using 0.5 as the threshold); and/or evaluating performance, e.g. assess model performance, for instance, using an accuracy metric. The model training may be fine-tuned or otherwise improved over successive iterations based on the performance of the previous iteration.

Accordingly, as shown in FIG. 6B, predictive models 626 based on pre-trained predictive models 648 and predictions 650 may each determine a score for the associated prompt, producing a 628 of k scores 628 relating to one of prompts 1 to k. As described herein, the score for each prompt may be based on a predicted probability (e.g. predictions 650) of receiving a defined feedback value on an output of the LLM generated based on that prompt and tabular data 620.

Prompt selector 600 may find the index of the max score, schematically shown by reference numeral 630. For example, if score 1 is the highest score, the index of score 1 is 1, relating to prompt 1. Similarly if score k is the highest score, the index of score k is k, relating to prompt k.

Prompt selector 600 may output the prompt according to the selected index, schematically shown by reference numeral 632. For example, if the index of the highest score is 5 (e.g. k≥5), then prompt 5 will be output by prompt selector 600 as the selected prompt, because prompt 5 is the prompt which is predicted as having the greatest probability of eliciting the pre-defined feedback value (e.g. a feedback value relating to “positive” feedback) for the input tabular data 620. If there is more than one max score (e.g. because the same max score was achieved by more than one prompt), then prompt selector 600 may be configured to choose randomly between the indices of the max scores.

The output selected prompt may be input to an LLM, for example automatically input to an LLM without a user or client first seeing the selected prompt.

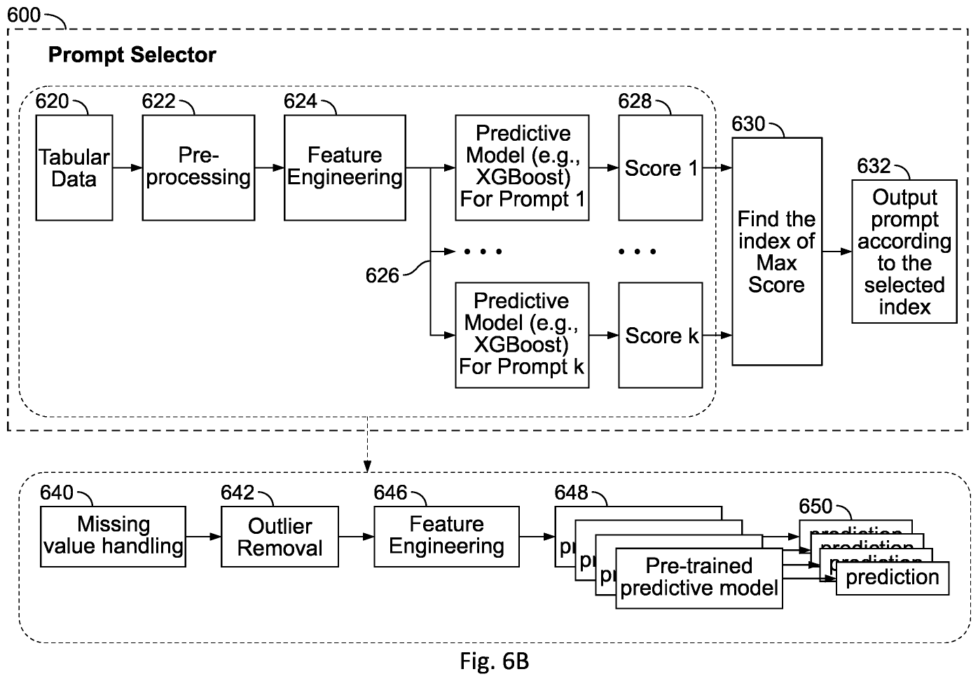

FIG. 7 shows schematically an example process 700, according to some embodiments of the invention. Process 700 may be divided into three main parts, relating to an initial process, a main process (e.g. a production client runtime process), and a process for the creation of new prompts in production.

The initial process may include the creation of k prompts 702, k being an integer. For example, creating k prompts as shown schematically by reference numeral 702 may include creating a first prompt, such as “Summarize the data below” and then creating k−1 variations of the first prompt, e.g. by emphasizing different instructions, points of view, and/or rephrasing the first prompt. The k prompts may be stored as a prompt stack 704, e.g. a set of predefined prompts.

The initial process may include choosing a random prompt (e.g. to ensure all prompts will receive feedback), shown schematically by reference numeral 706. For example, a prompt may be fetched randomly from prompt stack 704. The randomly selected prompt may be presented to a user 708 for feedback. Feedback and data from user 708 may be saved in a database 710. For example, feedback from user 708 may include a feedback value, which may relate to binary feedback, a rating on a scale, or a rating on a scale converted from textual feedback, as discussed herein.

Feedback and data saved in database 710 may be used to train k models to predict user feedback from data, in a stage represented schematically by reference numeral 712. For example, one or more processes shown in FIG. 6B for training a prompt selector may be used.

Pre-trained predictive models, for example k pre-trained predictive XGBoost models for each prompt, may be saved as a trained model stack 714.

In the main processes, a user 716 may provide data. User 716 may be the same as user 708 or may be a different user. For example, user 716 may be a client, such as client 560 shown in FIG. 5B. The data provided by user 716 may be tabular data that user 716 wants summarized by an LLM, e.g. a first set of data to be the subject of a prompt.

The data provided by user 716 may be used at a stage 718 to predict the best prompt based on the user data, and to choose the prompt with the highest score. For example, as described herein, one or more trained predictive models (e.g. from trained model stack 714) may be used to determine a score for each prompt of the pre-defined set of prompts in prompt stack 704. The score for each prompt may be based on a predicted probability of receiving a defined feedback value on an output of the LLM generated based on that prompt and the user data.

An ID of the highest scoring prompt may be used at a stage 720 to fetch the selected prompt from prompt stack 704. The prompt with the highest score may be displayed to user 716. Alternatively, the prompt with the highest score may be selected and automatically input to an LLM the prompt together with the data from the user. An output result generated by the LLM (e.g. generated based on the selected prompt and data from the user) may be displayed to user 716.

User 716 may provide feedback 722 on the prompt and/or output result generated by the LLM. As described herein, the feedback may include a feedback value which may correspond to binary feedback, a rating on a scale, or a rating on a scale converted from textual feedback. The feedback 722 and the data from user 716 which accompanied the prompt may be saved in database 710, for example for use in further training and improvement of the one or more predictive models.

The process of creating new prompts in production may include a stage 724 of creating j new prompts, where j is an integer, and where j may be less than, equal to, or greater than k. New prompts may be added to prompt stack 704. The creation of new prompts may include offline research, as described for offline research 532 shown in FIG. 5B.

In some embodiments, a new prompt may be created based on feedback or feedback values for one of the existing k prompts. For example, a feedback value 722 received for an output result generated by the LLM may be used to create at least one new prompt to be added to the pre-defined set of prompts in prompt stack 704. New prompts may be created by a human or a second LLM. For example, a second LLM may be used to create at least one variation of an existing prompt, using a prompt to the second LLM such as “Rewrite the below text”, where the below text is the existing prompt.

In a stage 726, new prompts may be assigned with a probability p, for example new prompts may be assigned p of the time. Probability p may be equal to j/(j+k), e.g. j divided by the sum of j and k. Other probabilities may be used. Feedback for the j new prompts may be recorded, for example as described for the k prompts. For example, if a new prompt was added to an existing stack of 9 prompts, the engineers can choose to select this prompt randomly 10% of the time, while choosing the best prompt 90% of the time. This proportion will define how “fast” user feedback will be collected for the new prompt.

In a stage 728, j new models may be trained to predict user feedback from data, for example as described in stage 712. In a stage 730, the newly trained models may be added to the trained model stack 714.

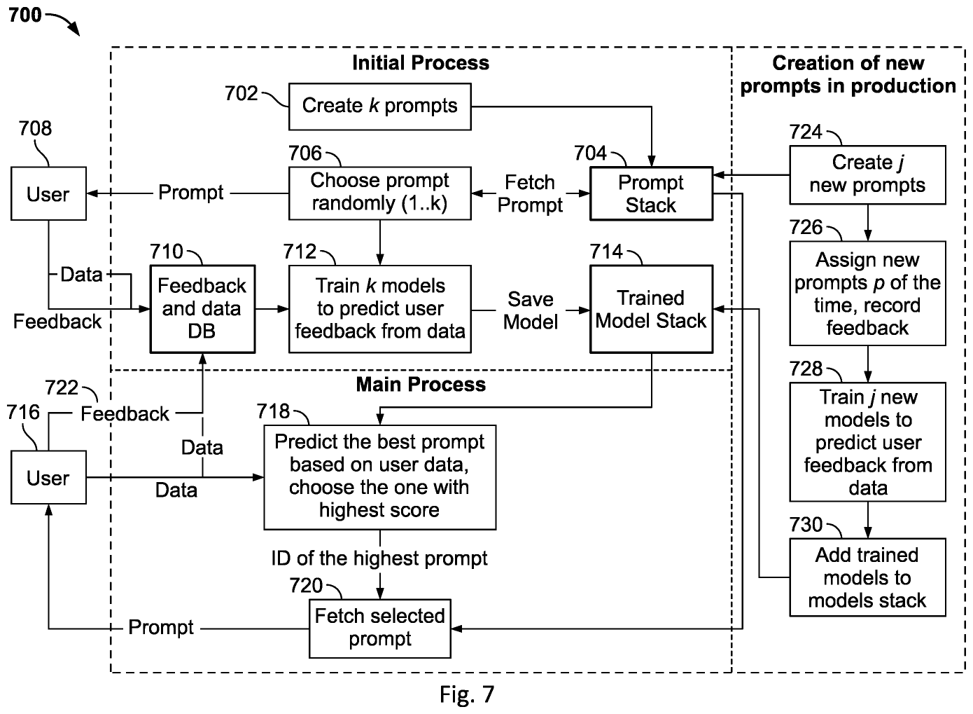

FIG. 8 shows an example data structure, according to some embodiments of the invention. An automatic prompt selector 800 according to some embodiments of the invention, may use user input 810 e.g. tabular data, and prompts 820 which may be stored as an array of texts. Automatic prompt selector 800 may be, or may be similar to, prompt selector 600 shown in FIGS. 6A and 6B, classifier 520 shown in FIG. 5B, a system executing the method of FIG. 3, and/or a system executing the process of FIG. 7.

User input can be imported from any data source, for example as tabular data. The structure of the data depends solely on the type of input. For example, a CSV (Comma Separated Value) file or an SQL (Structured Query Language) query.

User feedback may be stored as combined data (e.g. with a prompt and input data from a user) 830 for model training and further research. User feedback, e.g. from a user using a user terminal, may be stored as a feedback value, such as a binary feedback value (e.g. 0 or 1) derived from user interaction with a graphic feedback mechanism such as a thumbs up or thumbs down, a rating on a scale entered by a user, or a rating on a scale derived from textual/written feedback provided by a user.

Table 1 shows an example of combined data in the form of tabular data which concatenates the user input data with the chosen prompt index, and user feedback. Columns 1-4 “TRX_type”, “TRX_Date”, “Days_since_account open” and “Amount” represent the user input data, column 5 “Promptpresented” represents the ID or index of the prompt used, and column 6 “User_feedback” represents the feedback received (here from binary feedback).

TABLE 1

| | | Days_{—} | | | |
|---|---|---|---|---|---|
| | | since_{—} | | | |
| TRX_{—} | TRX_{—} | account_{—} | | Prompt_{—} | User_{—} |
| type | Date | open | Amount | presented | feedback |
| Check_{—} | 20 Jun. 2012 | 132 | 850 | 2 | Positive |
| deposit | | | | | |
| P2P | 8 Jul. 2012 | 158 | 15 | 2 | Negative |
| P2P | 9 Jul. 2012 | 159 | 80 | 3 | Positive |
| P2P | 10 Aug. 2012 | 190 | 190 | 9 | Positive |

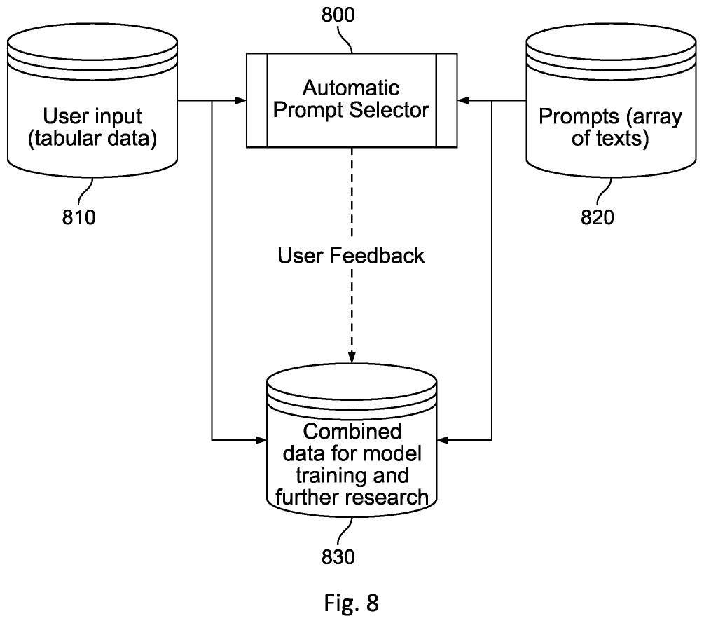

FIG. 9 shows a flowchart of a method 900 for determining an input to a generative artificial intelligence, according to some embodiments of the invention. The generative artificial intelligence may be, for example, a large language model.

Method 900 may include determining a score for one or more candidate inputs, the score based on a likelihood of receiving positive feedback on an output of the generative artificial intelligence generated from the candidate input (Step 910).

A candidate input may include a table of data and a prompt to summarize the table of data.

Method 900 may include identifying the candidate input with the best score (Step 920). For example, the best score may relate to the highest predicted probability of achieving positive feedback.

Positive feedback may include at least one of: an assigned positive value of binary feedback; a value relating to user input from an assigned positive graphic element of a user interface; a value within a predefined range of rating values on a scale; or textual feedback converted to a rating value on a scale by a second generative artificial intelligence configured to analyze textual feedback for positive keywords, wherein a predefined range of rating values on the scale are assigned as relating to positive feedback. For example, as described herein, positive feedback could come from a user interacting with a “thumbs up” or other suitable graphic symbol, providing a rating or score on a scale (such as a score out of 10) or writing a review of the output which is subsequently analyzed to determine if the output was suitable.

In some embodiments, method 900 may include submitting the candidate input with the best score to the first generative artificial intelligence, and receiving an output of the first generative artificial intelligence generated from the candidate input with the best score.

In some embodiments, method 900 includes receiving feedback on the output of the first generative artificial intelligence generated from the candidate input with the best score. As described herein, the feedback may relate to binary feedback; a rating on a scale; or a rating on a scale converted from textual feedback.

In some embodiments, the feedback may be used to improve the step of determining a score for future candidate inputs (e.g. Step 910).

Described now are simulation results according to some embodiments of the invention, demonstrating how feedback can be used to improve prompt selection. In this simulation, an LLM-based book summarization website is used, where a user can enter the name of a book and receive a brief summary of the book. The user can provide a thumbs up/down to the summary, representing positive/negative feedback. For the experimental data, user feedback was simulated using a second LLM trained to evaluate the book summary of the first LLM and provide positive or negative feedback.

Three prompts were created for summarizing the books. They were:

Prompt 0: “Please summarize in 2 sentences the book {book_name}”.

Prompt 1: “Give a very concise summary in only a few sentences of the book {book_name}”.

Prompt 2: “For the book below, give a very short 3 sentence summary describing the main plot”.

As used in prompts 0 and 1, {book_name} is a variable which is entered into the prompt automatically when the user types into the website the name of the book that they want summarized, e.g. “Frankenstein”. The variable {book_name} may be considered a set of user input data, e.g. a set of one element.

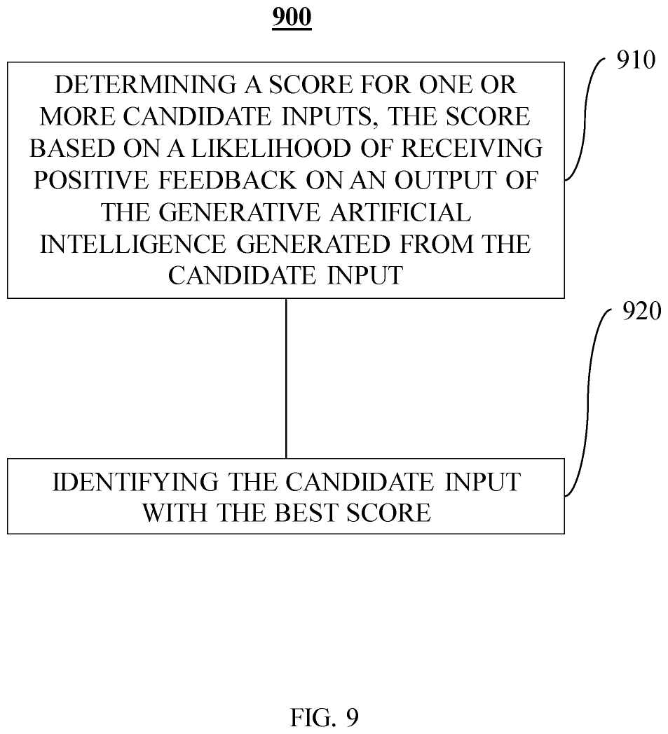

At a first step of the simulation, each query to the website tool fetched one of the three prompts randomly, to collect data on the full set of prompts. For each book, the tool also collected data from online resources regarding the genre, year of publication and length of the book (e.g. representing tabular data). FIG. 10 shows this data for the books Jane Eyre, pride and Prejudice, The Lord of the Rings: The Fellowship of the Ring, 1984, To Kill a Mockingbird, The Hobbit, and Harry Potter and the Sorcerer's Stone, used by the simulation according to some embodiments of the invention.

For the collected data, a model was created, so that the selection of prompts would not be random and would be based on the data, in accordance with embodiments of the invention. Results of model creation are shown in the prompt_id and feedback columns of FIG. 10. For example, when prompt 0 was used for data relating to Jane Eyre, the feedback was positive (e.g. 1). However, when prompt 0 (the same prompt) was used for data relating to Pride and Prejudice, the feedback was negative (e.g. 0).

In the simulation, the prompt selection for the user input book Frankenstein was tested. The tool fetched accompanying tabular data for Frankenstein as follows: “length”: 280, “year_of_publication”: 1818, “genre”: “Fantasy”.

This data was fed into the model, which in turns predicted the probability of eliciting a positive user experience for each prompt:

For prompt 0, the predicted probability for thumbs up was 61.89%.

For prompt 1, the predicted probability for thumbs up was 74.65%.

For prompt 2, the predicted probability for thumbs up was 82.83%.

Thus, the tool output the selected prompt as prompt 2, this being the prompt with the highest predicted probability of eliciting positive feedback based on training for similar books.

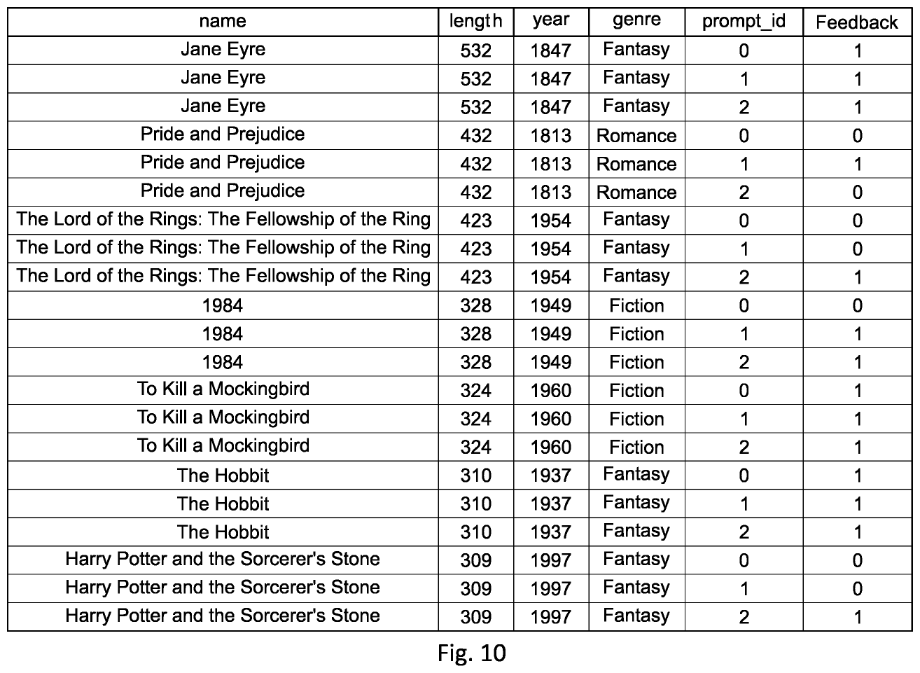

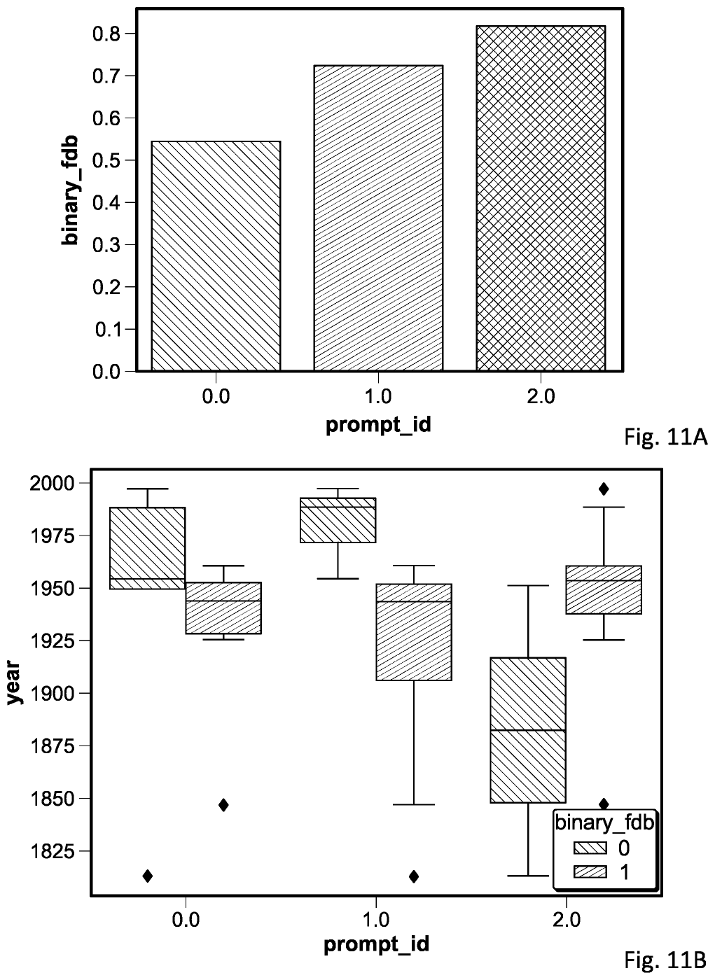

FIG. 11A is a graph showing the overall positive feedback average as a function of prompt index, according to some embodiments of the invention. Overall, users preferred Prompt 2. FIG. 11B is a graph showing how the year of publication (part of the tabular data) influences the feedback as a function of prompt index, according to some embodiments of the invention. As can be seen, results suggest that the first two prompts (prompt 0 and prompt 1) work better for older books, but the third prompt (prompt 2) elicited better user satisfaction for newer books.

As described herein, the invention may be embodied as a method or a system. Reference is now made to FIG. 12, which is a block diagram of an exemplary computing device 1200 which may be used with some embodiments of the present invention. For example, computing device 1200 may be, or elements of computing device 1200 may be included in, an LLM, a user terminal, and/or a server.

Computing device 1200 may include a controller or processor 1205 that may be, for example, a central processing unit processor (CPU), a chip or any suitable computing or computational device, an operating system 1215, a memory 1220, a storage 1230, input devices 1235 and output devices 1240.

Operating system 1215 may be or may include any code segment designed and/or configured to perform tasks involving coordination, scheduling, arbitration, supervising, controlling or otherwise managing operation of computing device 1200, for example, scheduling execution of programs. Memory 1220 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 1220 may be or may include a plurality of, possibly different, memory units. Memory 1220 may store for example, instructions to carry out a method (e.g., code 1225), and/or data such as user responses, interruptions, etc.

Executable code 1225 may be any executable code, e.g., an application, a program, a process, task or script. Executable code 1225 may be executed by controller 1205 possibly under control of operating system 1215. In some embodiments, more than one computing device 1200 or components of device 1200 may be used for multiple functions described herein. For the various modules and functions described herein, one or more computing devices 1200 or components of computing device 1200 may be used. Devices that include components similar or different to those included in computing device 1200 may be used, and may be connected to a network and used as a system. One or more processor(s) 1205 may be configured to carry out embodiments of the present invention by for example executing software or code. Storage 1230 may be or may include, for example, a hard disk drive, a floppy disk drive, a Compact Disk (CD) drive, a CD-Recordable (CD-R) drive, a universal serial bus (USB) device or other suitable removable and/or fixed storage unit. Storage 1230 may include cloud-based storage. Storage 1230 may include database storage. In some embodiments, some of the components shown in FIG. 12 may be omitted.

Input devices 1235 may be or may include a mouse, a keyboard, a touch screen or pad or any suitable input device. It will be recognized that any suitable number of input devices may be operatively connected to computing device 1200 as shown by block 1235. Output devices 1240 may include one or more displays, speakers and/or any other suitable output devices. It will be recognized that any suitable number of output devices may be operatively connected to computing device 1200 as shown by block 1240. Any applicable input/output (I/O) devices may be connected to computing device 1200, for example, a wired or wireless network interface card (NIC), a modem, printer or facsimile machine, a universal serial bus (USB) device or external hard drive may be included in input devices 1235 and/or output devices 1240.

According to some embodiments of the invention, a computing device such as a user terminal may present an output of an LLM to a user on an output device such as a display, and the user may use an input device such as a mouse to click on a graphic symbol relating to positive or negative feedback in order to provide feedback on the output of the LLM. The feedback may be used according to embodiments of the invention to improve prompt selection methods, as described herein.

Embodiments of the invention may include one or more article(s) (e.g., memory 1220 or storage 1230) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

Embodiments of the invention may improve the technologies of generative artificial intelligence, such as large language models by improving prompt engineering and prompt selection, as well as improving the technology of computer use and automation analysis by using specific algorithms to efficiently analyze and summarize large pools of data, such as tabular data, a task which is impossible, in a practical sense, for a person to carry out.

As described herein, a predictive model, classifier, and/or LLM may be, or may include elements of, a machine learning model and/or artificial neural network, and may receive input data. A predictive model according to embodiments of the invention may output predictions calculated, estimated, or derived on the basis of function approximation and/or regression analysis.

An artificial neural network may include neurons or nodes organized into layers, with links between neurons transferring output between neurons. Aspects of a neural network may be weighed, e.g. links may have weights, and training may involve adjusting weights. A positive weight may indicate an excitatory connection, and a negative weight may indicate and inhibitory connection. A neural network may be executed and represented as formulas or relationships among nodes or neurons, such that the neurons, nodes, or links are “virtual”, represented by software and formulas, where training or executing a neural network is performed, for example, by a conventional computer or GPU (such as computing device 1200 in FIG. 12).

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for selecting a prompt to input to a large language model (LLM), the method comprising:
determining, by a predictive model and for a first set of data to be the subject of a prompt of a pre-defined set of prompts, a score for each prompt of the pre-defined set of prompts,
wherein the score for each prompt is based on a predicted probability of receiving a defined feedback value on an output of the LLM generated based on that prompt and the first set of data;
inputting to the LLM the prompt with the highest score and the first set of data; and
outputting a result generated by the LLM based on the input prompt and the first set of data.

2. The method of claim 1, wherein the predictive model is pre-trained based on feedback values for a training set of outputs of the LLM generated based on each prompt of the pre-defined set of prompts and one or more training sets of data.

3. The method of claim 1, wherein the first set of data is a set of tabular data.

4. The method of claim 1, comprising receiving a feedback value on the output result generated by the LLM.

5. The method of claim 4, wherein the feedback value comprises one of: binary feedback; a rating on a scale; and a rating on a scale converted from textual feedback.

6. The method of claim 4, wherein the feedback value on the output result generated by the LLM is used to further train the predictive model.

7. The method of claim 4, wherein the feedback value on the output result generated by the LLM is used to create at least one new prompt to be added to the pre-defined set of prompts.

8. A system for selecting a prompt to input to a large language model (LLM), the system comprising:
at least one computer processor; and
a computer readable storage medium comprising instructions which, when executed by the at least one computer processor, cause the at least one computer processor to:
execute a predictive model to determine, for a first set of data to be the subject of a prompt of a pre-defined set of prompts, a score for each prompt of the pre-defined set of prompts,
wherein the score for each prompt is based on a predicted probability of receiving a defined feedback value on an output of the LLM generated based on that prompt and the first set of data;
input, to the LLM, the prompt with the highest score and the first set of data; and
output a result generated by the LLM based on the input prompt and the first set of data.

9. The system of claim 8, wherein the predictive model is pre-trained based on feedback values for a training set of outputs of the LLM generated based on each prompt of the pre-defined set of prompts and one or more training sets of data.

10. The system of claim 8, wherein the first set of data is a set of tabular data

11. The system of claim 8, wherein the at least one computer processor is configured to receive a feedback value on the output result generated by the LLM.

12. The system of claim 11, wherein the feedback value comprises one of: binary feedback; a rating on a scale; or a rating on a scale converted from textual feedback.

13. The system of claim 11, wherein the at least one computer processor is configured to use the feedback value on the output result generated by the LLM to further train the predictive model.

14. The system of claim 11, wherein the at least one computer processor is configured to use the feedback value on the output result generated by the LLM to create at least one new prompt to be added to the pre-defined set of prompts.

15. A method for determining an input to a first generative artificial intelligence, the method comprising:
determining a score for one or more candidate inputs, the score based on a likelihood of receiving positive feedback on an output of the first generative artificial intelligence generated from the candidate input; and
identifying the candidate input with the best score.

16. The method of claim 15, wherein a candidate input comprises a table of data and a prompt to summarize the table of data.

17. The method of claim 15, wherein positive feedback comprises at least one of: an assigned positive value of binary feedback; a value relating to user input from an assigned positive graphic element of a user interface; a value within a predefined range of rating values on a scale; or textual feedback converted to a rating value on a scale by a second generative artificial intelligence configured to analyze textual feedback for positive keywords, wherein a predefined range of rating values on the scale are assigned as relating to positive feedback.

18. The method of claim 15, comprising:
submitting the candidate input with the best score to the first generative artificial intelligence; and
receiving an output of the first generative artificial intelligence generated from the candidate input with the best score.

19. The method of claim 18, comprising receiving feedback on the output of the first generative artificial intelligence generated from the candidate input with the best score.

20. The method of claim 19, wherein the feedback is used to improve the step of determining a score for future candidate inputs.
